(19) United States
(12) Patent Application Publication
(10) Pub. No.: US 2012/0137595 A1
(43) Pub. Date: Jun. 7, 2012

(54) SNAP ARM UNIT FOR A DOOR INTERLOCKING DEVICE

(75) Inventor: Andreas Bockler, Rothenburg o. d. Tauber (DE)

(73) Assignee: ELECTROLUX HOME PRODUCTS CORPORATION N.V., Brussel (BE)

(21) Appl. No.: 13/390,409

(22) PCT Filed: Aug. 4, 2010
(86) PCT No.: PCT/EP10/04771

§ 371 Date: Feb. 14, 2012

(30) Foreign Application Priority Data
Aug. 29, 2009 (EP) 09011104.8

(51) Int. Cl. E05C 1/08; E05C 19/06; E06B 5/00; E05C 19/00

(52) U.S. Cl. 49/503; 292/2; 292/137

(57) ABSTRACT

A snap arm unit (10) for a door interlocking device includes a snap arm element (14) having a least one outwardly protruding interlocking snap arm (26). The snap arm unit comprises a housing (16) receivable in a door structure or in a frame structure and a connecting element (18) fixable to the housing (16). The snap arm element (14) is fixable to the connecting element (18) by means of a snap-fit.

### TECHNICAL FIELD

The present invention relates to a snap arm unit for a door interlocking device, comprising a snap arm element having at least one outwardly protruding interlocking snap arm. Moreover, the present invention relates to a door interlocking device comprising such a snap arm unit as well as to a domestic appliance comprising such a door interlocking device.

A domestic appliance of the above mentioned kind is for example known from DE-A-23 39 457. This document discloses a microwave oven which comprises a housing defining a cavity for receiving food stuff to be heated. A sideways opening door is linked to the housing for optionally opening and closing the cavity. In order to lock the door in its closed state, a door interlocking device is provided. The door interlocking device comprises a snap arm unit having a snap arm element with three outwardly protruding interlocking snap arms. Moreover, it comprises a receiving unit for snap-fittingly receiving the interlocking snap arms of the snap arm unit in the closed state of the door. According to the disclosed embodiment, the snap arm unit is fixed to the door and the receiving unit is provided at the front side of the housing. The snap arm unit is composed of a one-piece longish bar-like metal component which is screwed on the front end of the door. Integrally made with the bar-like component are the three protruding snap arm elements which project towards the housing in order to be received by corresponding holes of the receiving unit in the closed state of the door.

The door is normally a pre-assembled subassembly which is installed in the aggregate during the final assembly of the microwave. Since the door-subassembly often needs to be stored temporarily and/or needs to be transported, it turns out to be a drawback that the snap arm elements of the snap arm unit protrude from the subassembly, because they can easily become damaged.

In order to overcome this drawback, many manufacturers do not screw the snap arm units to the door assemblies until the final assembly of the oven. However, the attachment of the snap arm units to the doors takes a lot of time, what is not desirable during the final assembly.

It is an object of the present invention to provide a snap arm unit for a door interlocking device the installation of which can be completed during the final assembly in a quick and easy manner. Moreover, it is an object of the present invention to provide a door interlocking device comprising such a snap arm unit as well as a domestic appliance, in particular a domestic cooking oven, comprising such a door interlocking device.

In order to achieve this object the present invention provides a snap arm unit of the above mentioned kind, which is characterized in that the snap arm unit comprises a housing receivable in a door structure or in a frame structure and a connecting element which is guided within said housing, wherein the snap arm element is fixable or fixed to said connecting element by means of a snap-fit (clip or snap connection).

Owing to this structure of the snap arm unit the housing and the connecting element can be assembled at a door structure or at a frame structure of an appliance during a pre-assemble step. During the final assembly the snap arm element can be clipped to the connecting element in a quick and easy manner thanks to the snap-fit connection and there are no tools necessary for the installation of the snap arm unit, which is advantageous with respect to a fast and comfortable final assembly.

According to an embodiment of the present invention the snap arm element comprises outwardly protruding engaging hooks which are snap-fittingly receivable in corresponding engaging recesses formed in said connecting element or vice versa. This ensures a firm connection while maintaining a simple structure.

The snap arm unit preferably comprises a resilient element, in particular a helical and/or compression spring. The resilient element exerts a resilient force on the connecting element, which is generally directed in a guiding direction along which the connecting element is guided within the housing. The resilient element or spring can be fixed or mounted on one side to the housing, in particular on a projection of the housing being arranged in particular at the bottom of a receiving space of the housing, and on the other side to the connecting element, in particular arranged within a receiving space within the connecting element.

According to an embodiment of the present invention, the connecting element is slidingly receivable in said housing. Thus, the connecting element can be easily inserted in the housing during the corresponding assembly step. Preferably, the connecting element comprises a guiding projection slidingly receivable in a guiding recess formed in said housing or vice versa.

In a preferred embodiment the snap arm unit comprises at least one elastic snap arm engaging a or entering a snap recess when the connecting element reaches a predetermined position within the housing wherein the elastic snap arm is arranged at the connecting element and the snap recess is provided at the housing or vice versa.

Preferably, in this embodiment, the resilient force of the resilient element is directed to press or presses the elastic snap arm into the snap recess or against a side wall of the recess in order to keep the connecting element in the predetermined position.

The snap arm element, the housing and/or the connecting element are preferably made of plastics, in particular as single-piece and/or injection-moulded parts.

Moreover, the present invention provides a door interlocking device comprising a snap arm unit of the above mentioned kind and a receiving unit for receiving the interlocking snap arm of the snap arm unit in a snap-fitting or snapping manner. Preferably, the receiving unit, during a locking or unlocking movement, moves or presses the interlocking snap arm of the snap arm element and thereby the connecting element within the housing against the resilient force of the resilient element and thereafter allows the resilient element to press or move the connecting element and thereby the interlocking snap arm of the snap arm element back into a previous position relative to the housing.

Furthermore, the present invention provides a domestic appliance comprising a door interlocking device of the above mentioned kind, wherein the snap arm unit is fixed to a door structure of the appliance and the receiving unit is fixed to a frame structure of the appliance (or: an appliance housing) or vice versa. The domestic appliance may be in particular a domestic cooking oven including e.g. a microwave oven or a refrigerator or the like.

According to an embodiment of the present invention the door structure or the frame structure of the appliance, which receives the housing of the snap arm unit, comprises a rail-like guiding structure for receiving the housing, a stopper for positioning the housing in a predetermined position and an engaging hook for snap-fittingly engaging the housing in said predetermined position.

Further details and advantages of the present invention become apparent from the following description of exemplary embodiments of a door interlocking device according to the present invention with reference to the accompanying drawings. In the drawings

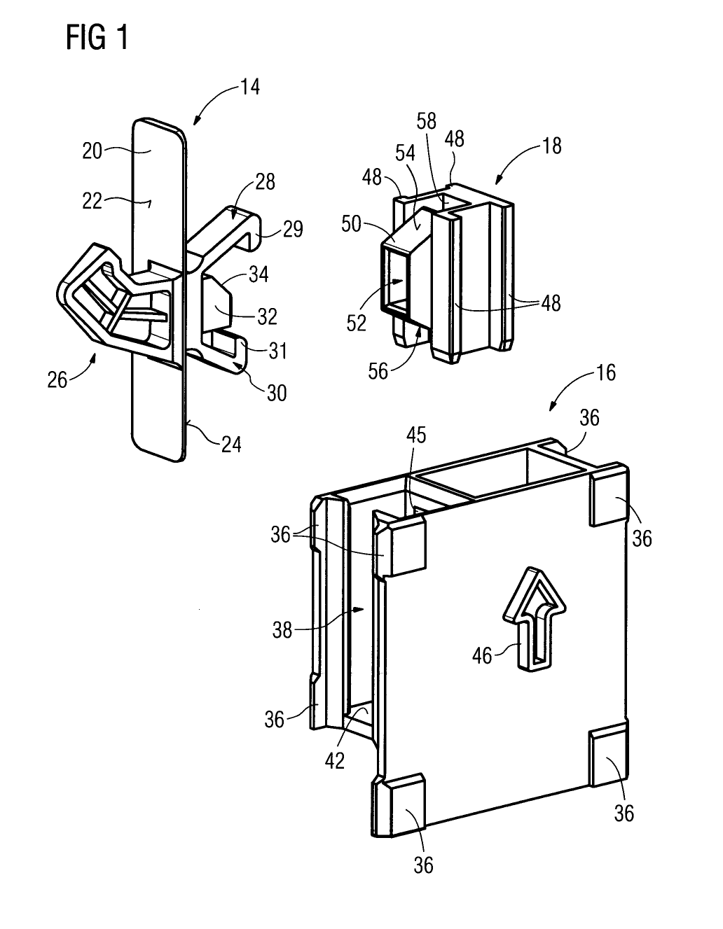

FIG. 1 is an exploded perspective view of a snap arm unit of a door interlocking device according to an embodiment of the present invention;

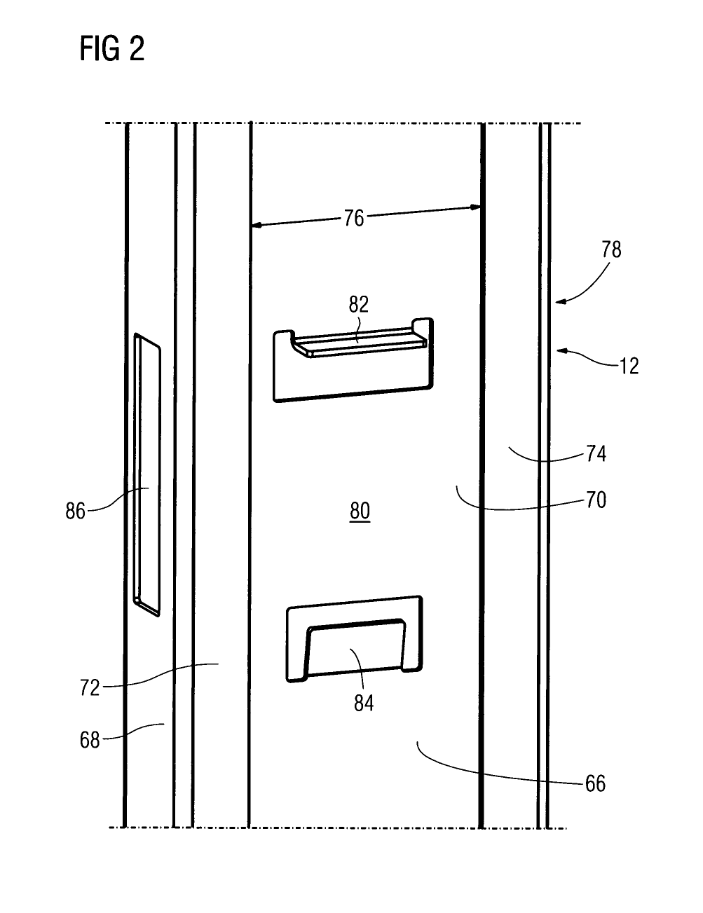

FIG. 2 is a perspective front view of a door structure of a domestic appliance according to an embodiment of the present invention into which the snap arm unit depicted in FIG. 1 is to be inserted;

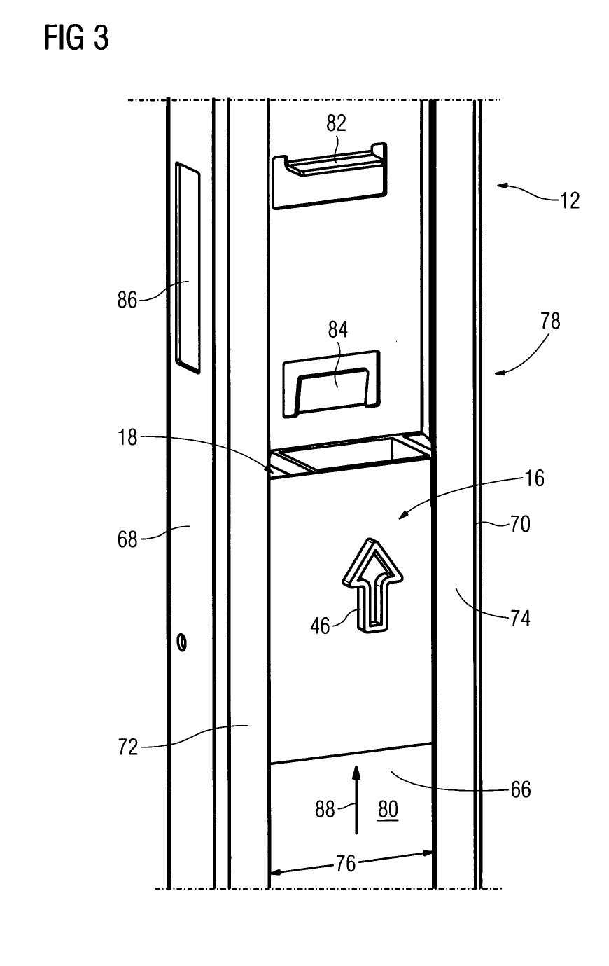

FIG. 3 is a perspective front view of the door structure shown in FIG. 2, wherein a housing and a connecting element of the snap arm unit depicted in FIG. 1 is received therein;

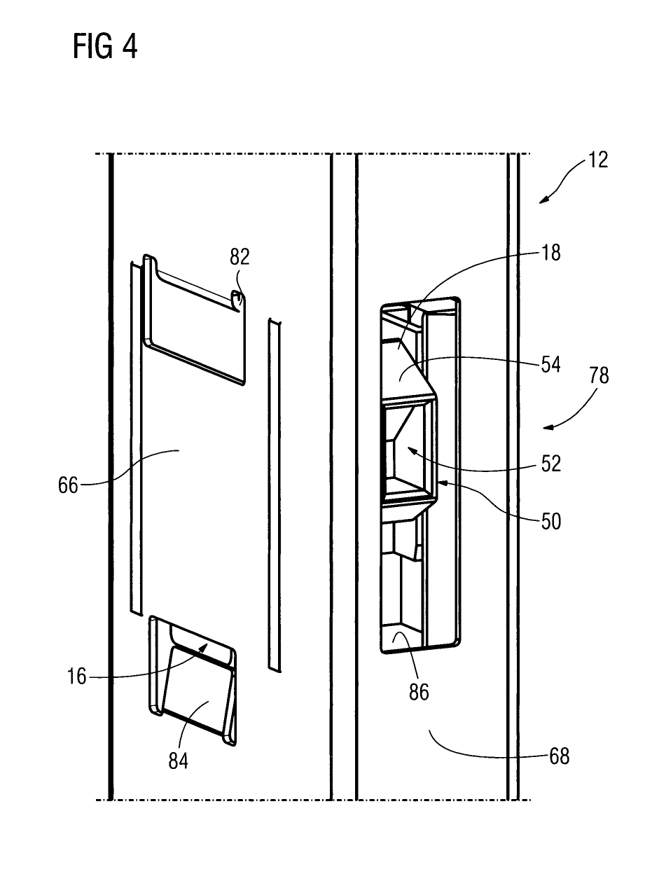

FIG. 4 is a perspective rear view of the door structure shown in FIG. 3;

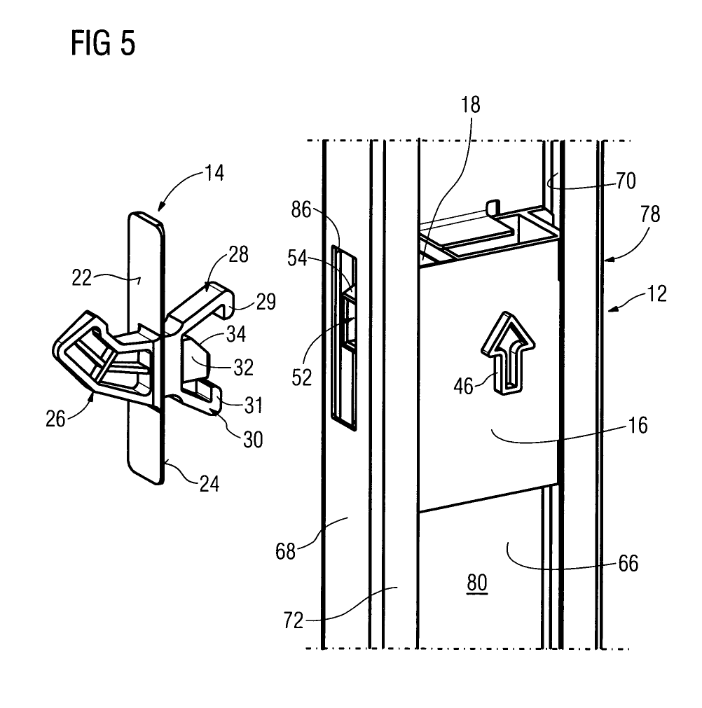

FIG. 5 is a perspective front view of the door structure shown in FIGS. 3 and 4 prior to the assembly of a snap arm element of the snap arm unit;

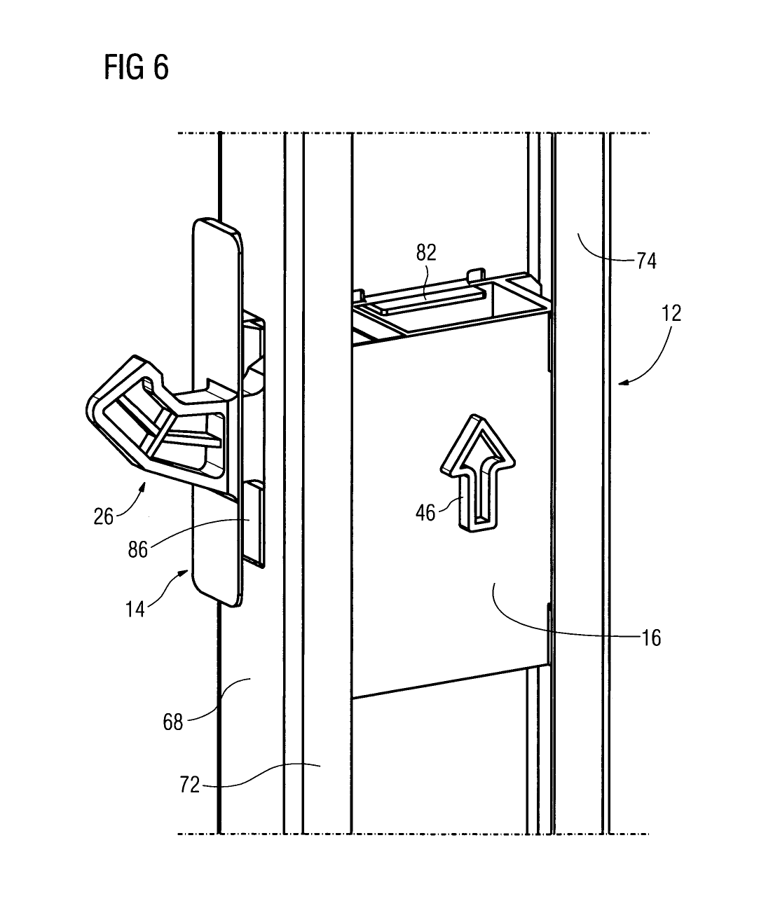

FIG. 6 is a perspective front view of the door structure shown in FIGS. 4 and 5 showing the snap arm element in its assembled state;

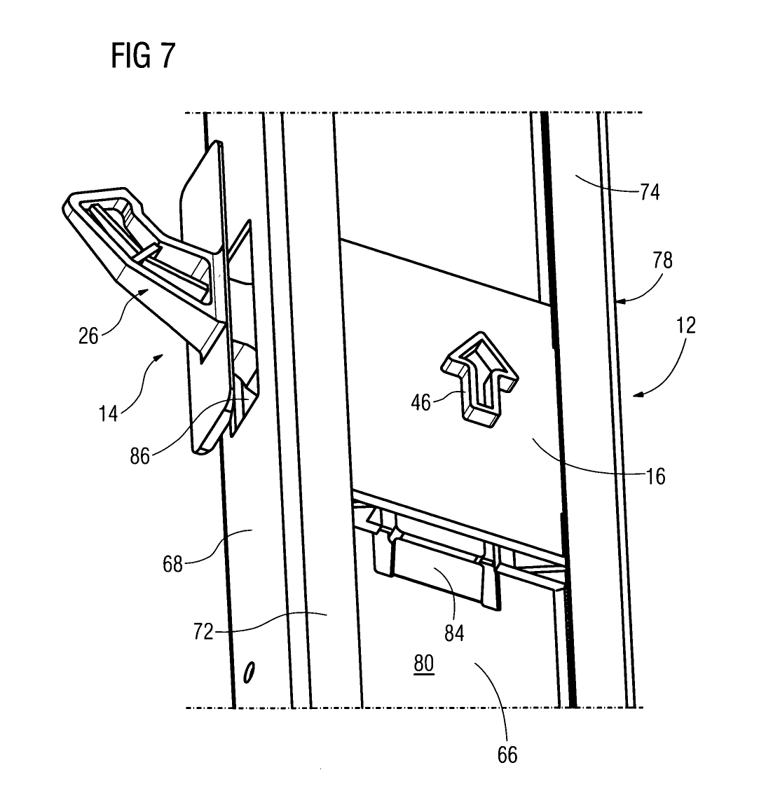

FIG. 7 is a further perspective front view of the door structure illustrated in FIGS. 3 and 4 showing the snap arm element in its assembled state;

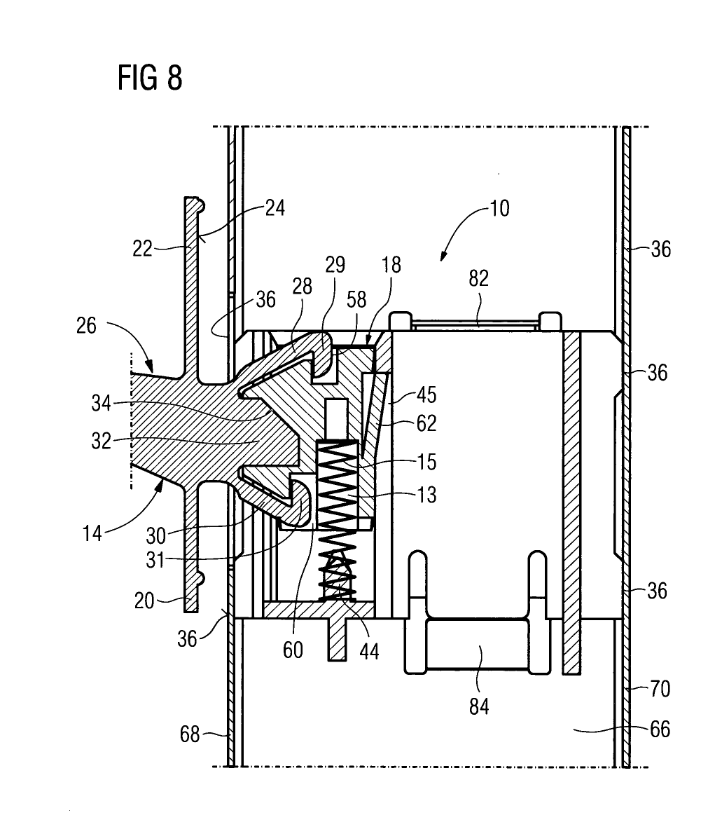

FIG. 8 is a sectional view of the door structure illustrated in FIGS. 3 and 4 showing the snap arm element in its assembled state; and

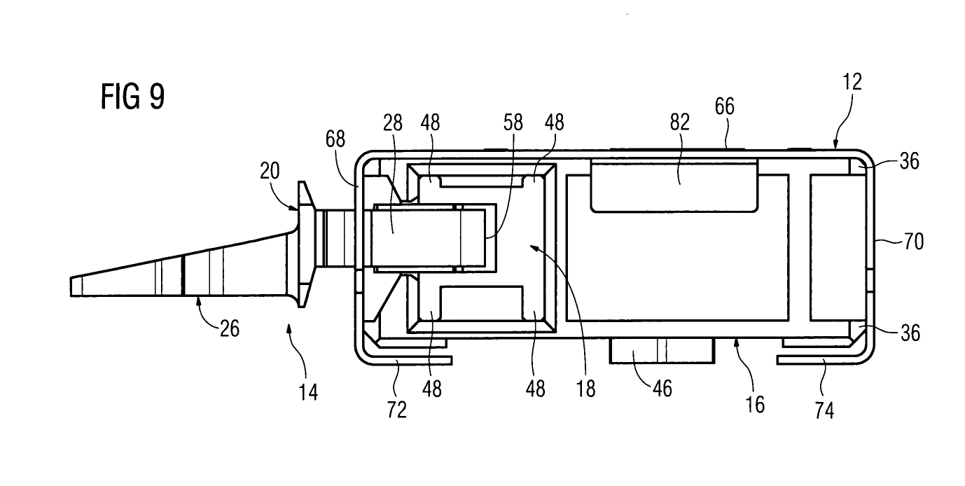

FIG. 9 is a top view of the door structure illustrated in FIGS. 3 and 4 showing the snap arm element in its assembled state.

FIGS. 1 to 9 show an embodiment of a snap arm unit 10 according to the present invention which is to be installed in a pillar 12 of a door structure of a domestic appliance, such as a microwave oven or other cooking oven or the like.

The snap arm unit 10 is composed of a snap arm element 14, a housing 16 and a connecting element (or: runner) 18, which are depicted in detail in the exploded view of FIG. 1.

The snap arm element 14 is a one-piece component made of plastics. It comprises a longish plate-like base portion 20 having an upper side 22 and a lower side 24. Moreover, an interlocking snap arm 26 is provided, which outwardly protrudes from the upper side 22 of the base portion 20 essentially at right angle. The interlocking snap arm has a hook-like shape in order to engage a receiving unit arranged at the frame structure of the domestic appliance, which is not shown throughout the figures. Furthermore, the snap arm element 14 comprises two engaging hooks 28 and 30 with respective hook section 29 and 31, wherein the engaging hooks 28 and 30 protrude from the lower side 24 of the base portion 20 away from each other. The engaging hook 28 is longer than the engaging hook 30. Between the engaging hooks 28 and 30 an alignment projection 32 is provided, which also protrudes from the lower side 24 of the base portion 20 essentially at right angle. The alignment projection 32 is shaped as a cuboid with a bevelled lateral edge 34.

The housing 16 is a one-piece component made of plastics. It is essentially formed as a hollow cuboid, whose outer dimensions are chosen in such a manner that the housing 16 is receivable in a rail-like guiding structure of the pillar 12, as it is described later. More precisely, the housing 16 comprises a series of contact surfaces 36, which protrude from the different sides of the housing and come into contact with the rail-like structure of the pillar 12 when the housing 16 is inserted therein.

At one side of the housing 16, a receiving space 38 is provided for receiving and guiding the connecting element 18, which receiving space 38 is in particular of a hollow cuboid shape. The inner wall of the receiving space 38 serves as guiding surface for guiding projections 48 of the connecting element 18 which is slide on the inner wall of the receiving space 38 and are thereby guided linearly and vertically while inserting the connecting element 18 into the housing 16, as it is described later. Moreover, the receiving space 38 is closed by a lower wall 42 in order to define a stopper for the connecting element 18.

A pin-like projection 44 extends from the lower wall 42 inside the receiving space 38 at right angle and bears or carries a helical compression spring 15 at the lower end. The compression spring 15 extends in an upward direction into a receiving space 13 within the connecting element 18 and at its upper end rests against a shoulder at the end of the receiving space 13. Therefore the compression spring 15 exerts a resilient force on the connecting element 18 pushing the connecting element 18 upwardly.

Moreover the receiving space 38 is formed with or has a snap recess 45 in its upper portion, which serves for receiving an elastic snap arm or hook 62 of the connecting element 18, as it is described later. At its upper side the housing 16 is provided with a marker 46 in the form of an arrow in order to indicate the assembly direction for inserting the housing 16 into the rail-like structure of the pillar 12.

The connecting element 18 is a one-piece block-like component made of plastics of in general substantially cuboid shape. Sideways or at the sides or corners the connecting element 18 is provided with e.g. four guiding projections 48, which come into contact with the housing 16 when the connecting element 18 is inserted into the receiving space 38 of the housing 16 and slide on the inner wall of the housing 16 surrounding the receiving space 38. The outer dimensions of the guiding projections 48 of the connecting element 18 are only lightly smaller than the corresponding inner dimensions of the receiving space 38 to allow for enough play for the sliding movement but still provide a tight and secure guiding function.

Moreover, the connecting element 18 is formed with a trapezoid-like portion 50, whose outer dimensions essentially correspond to the dimensions of the interspace defined by the engaging hooks 28 and 30 of the snap arm element 14. The trapezoid-like portion 50 is formed with a receiving space 52, whose dimensions essentially correspond to the ones of the alignment projection 32 of the snap arm element 14 in order to receive the alignment projection 32. Inclined faces 54 and 56 of the trapezoid-like portion 50, serve as spreading faces for spreading the engaging hooks 28 and 30 of the snap arm element 14 during the corresponding assembly step. Right behind the inclined faces 54 and 56 engaging recesses 58 and 60 are formed for receiving the hook sections 29 and 31 of the engaging hooks 28 and 30. At the side wall of the connecting element opposite to the trapezoid-like portion 50 the elastic snap arm 62 is provided for engaging the snap arm projection of the housing 16 when inserting the connecting element 18 into the housing 16. Moreover, an alignment recess 64 is formed at the bottom side of the connecting element 18 in order to receive the alignment projection 44 of the housing 16 during the assembly.

The pillar 12 is a one-pieced component, which is produced from a metal sheet by means of cutting and bending. The pillar 12 comprises a longish base wall 66, two side walls 68 and 70, which extend from the base wall 66 at right angles, and two upper walls 72 and 74, which extend from the side walls 68 and 70 at right angle such that they face each other and define a clearance 76 there between. The base wall 66, the side walls 68 and 70 and the upper walls 72 and 74 form a rail-like guiding structure 78 defining a receiving space 80 for receiving the housing 16. Accordingly, the dimensions of the rail-like guiding structure 78 are adapted to the outer dimensions of the housing 16. The base wall 66 is provided with a stopper 82 which is e.g. produced by means of cutting and bending. The stopper 82 extends from the base wall 66 into the receiving space 80 essentially at right angle in order to define a stop for the housing 16 when the housing 16 is inserted into the rail-like guiding structure 78 of the pillar 12. Below the stopper 82 the base wall 66 is further provided with an engaging hook 84 which is also formed by means of cutting and bending. The engaging hook 84 is slightly bent into the receiving space 80 and faces the stopper 82. The side wall 68 of the pillar 12 is provided with a longish hole 86 for gaining access to the connecting element 18 in the assembled state of the snap arm unit 10, as it is described later.

In the following, the assembly of the snap arm unit 10 will be described.

For a start the compression spring 15 is inserted on the projection 44 and the connecting element 18 is inserted into the receiving space 38 of the housing 16, the compressions spring 15 entering the receiving space 13 in the connecting element 18. Now, during insertion the guiding projections 48 of the connecting element 18 slide along the inner surfaces of the housing 16, and the hook or elastic snap arm 62 of the connecting element 18 is pressed down towards the connecting element 18. The connecting element 18 moves against the resilient force of the compression spring 15 until the elastic snap arm 62 of the connecting element 18 snaps into the snap recess 45 at the wall of the housing 16 delimiting the receiving space 38. Thus, the connecting element 18 is held in position within the receiving space 38 of the housing 16 by means of a snap-fitting connection the snap arm 62 being pressed upwards against the upper side wall of the recess 45 by the resilient force of the compression spring 15.

Thereafter, the housing 16 along with the connecting element 18 inserted therein is introduced into the rail-like guiding structure 78 of the pillar 12 and is moved in the direction of arrow 88. During this movement the contact surfaces 36 of the housing 16 are in sliding contact with the walls 66, 68, 70, 72 and 74 of the rail-like guiding structure 78. As soon as the housing 16 reaches the engaging hook 84, the engaging hook 84 is pressed down by means of the housing 16 such that the housing 16 can pass it. The movement continuous, until the housing 16 comes to rest at the stopper 82 of the pillar 12. In this position, the entire housing 16 has passed the engaging hook 84, such that the engaging hook 84 snaps behind the housing 16 in order to fix it in position, as it is shown in FIG. 4. In this condition the connecting element 18 is accessible through the hole 86 formed in the side wall 68 of the pillar 12.

Now, the preassembly of the snap arm unit 10 is completed.

In a final assembly step, as it is shown in FIGS. 5 to 9, the snap arm element 14 is inserted through the hole 86 of the side wall 68 such that the alignment projection 32 of the snap arm element 14 is introduced into the receiving space 52 of the connecting element 18. The bevelled lateral edge 34 of the alignment projection 32 thereby prevents that the snap arm element 14 is accidentally turned by 180°. During this insertion movement the hook sections 29 and 31 of the engaging hooks 28 and 30 of the snap arm element 14 are guided by the inclined faces 54 and 56 of the trapezoid-like portion 50 and are spreaded until they snap into the corresponding engaging recesses 58 and 60. If necessary The connecting element 18 can be slightly moved downwards against the compression spring 15 to facilitate the mounting of the snap arm element 14.

Now, the final assembly of the snap arm unit 10 is completed.

The snap arm element 14 fixed to the connecting element 18 is now movable linearly in the vertical direction together with the movement of the connecting element 18 within the receiving space 38 of the housing 16 against or with the resilient force of the compression spring 15 allowing for a latch movement of the snap arm 26 in order to lock or unlock the door when a corresponding interlocking counterpart at the door frame hits against the snap arm 26 mounted at the door and moves it against the force of the compression spring 15. After the passing of the interlocking counterpart the snap arm snaps back in its original position because of the resilient force of the compression spring 15.

### LIST OF REFERENCE NUMERALS

10 snap arm unit
12 pillar
13 receiving space
14 snap arm element
15 compression spring
16 housing
18 connecting element (or: runner)
20 base portion
22 upper side
24 lower side
26 interlocking snap arm
29, 31 hook section
28, 30 hooks
32 alignment projection
34 lateral edge
36 contact surface
38 space
40 guiding recess
42 lower wall
44 pin-like projection
45 snap recess
46 marker
48 guiding projections
50 trapezoid-like portion
52 receiving space
54, 56 inclined faces
58, 60 engaging recesses
62 elastic snap arm or hook
64 alignment recess
66 base wall
68, 70 side walls
72, 74 upper walls
76 clearance
78 rail-like guiding structure
80 receiving space
82 stopper
84 engaging hook
86 hole
88 arrow

1. Snap arm unit (10) for a door interlocking device, comprising a snap arm element (14) having at least one outwardly protruding interlocking snap arm (26) a housing (16) receivable in a door structure or in a frame structure and a connecting element (18) which is guided within said housing (16), wherein the snap arm element (14) is fixed or fixable to said connecting element (18) by means of a snap-fit.

2. Snap arm unit (10) according to claim 1, wherein the snap arm element (14) comprises outwardly protruding engaging hooks (28, 30) which are snap-fittingly receivable in corresponding engaging recesses (58, 60) formed in said connecting element (18) or vice versa.

3. Snap arm unit (10) according to claim 2, further comprising a resilient element, which resilient element (15) exerts a resilient force on the connecting element (18), in a guiding direction along which the connecting element (18) is guided within the housing (16).

4. Snap arm unit (10) according to claim 3, wherein the resilient element (15) is fixed or mounted on one side to the housing (16), and on the other side to the connecting element (18).

5. Snap arm unit (10) according to claim 1, wherein the connecting element (18) is slidingly receivable in said housing (16) and/or comprises a guiding projection (48) slidingly receivable in a guiding recess (40) formed in said housing (16) or vice versa.

6. Snap arm unit (10) according to claim 3, comprising an elastic snap arm (62) engaging a snap recess (45) when the connecting element (18) reaches a predetermined position within the housing (16) wherein the elastic snap arm (62) is arranged at the connecting element (18) and the snap recess (45) is provided at the housing (16) or vice versa.

7. Snap arm unit (10) according to claim 6, wherein the resilient force of the resilient element (15) is directed to press or presses the elastic snap arm (62) into the snap recess (45) or against a side wall of the recess (45) in order to keep the connecting element (18) in the predetermined position.

8. Snap arm unit (10) according to claim 1, wherein the snap arm element (14), the housing (16) and the connecting element (18) each are made of plastic in at least one of a single-piece or an injection molded part.

9. Door interlocking device comprising a snap arm unit (10) according to claim 3 and a receiving unit for receiving the interlocking snap arm (26) of the snap arm unit (10) in a snap-fitting or snapping manner.

10. Door interlocking device according to claim 9, wherein the receiving unit during a locking or unlocking movement moves or presses the interlocking snap arm (26) of the snap arm element (14) and thereby the connecting element (18) within the housing (16) against the resilient force of the resilient element (15) and thereafter allows the resilient element (15) to press or move the connecting element (18) and thereby the interlocking snap arm (26) of the snap arm element (14) back into a previous position relative to the housing (16).

11. A domestic appliance comprising: a door structure (12) and a frame structure, a door interlocking device comprising a snap arm unit and a receiving unit for the interlocking snap arm unit coupled in a snap-fitting or snapping manner, wherein the snap arm unit (10) is fixed to the door structure (12) and the receiving unit is fixed to the frame structure or vice versa, and the snap arm unit includes a snap arm element having at least one outwardly protruding snap arm, a housing receivable in the door structure or in the frame structure, a connecting element that is guided within the housing, with the snap arm element being fixed or fixable to the connecting element by means of a snap-fit.

12. The domestic appliance according to claim 11, wherein the door structure (12) or the frame structure, which receives the housing of the snap arm unit (10), comprises a rail-like guiding structure (78) for receiving the housing (16), a stopper (82) for positioning the housing (16) in a predetermined position and an engaging hook (84) for snap-fittingly engaging the housing (16) in said predetermined position.

13. The snap arm unit (10) according to claim 3, wherein the resilient element (15) is fixed or mounted on one side to the housing (16) on a projection (44) of the housing (16) that is positioned at the bottom (42) of a receiving space (38) of the housing (16)

14. The snap arm unit (10) according to claim 13, wherein the resilient element, on the other side to the connecting element (18), is positioned within a receiving space (13) within the connecting element (18).

15. The domestic appliance of claim 11, wherein the snap arm unit further comprises a resilient element that exerts a resilient force on the connecting element in a guiding direction along which the connecting element is guided within the housing.

16. The domestic appliance of claim 15, wherein the resilient element is one of a helical or compression spring.

17. The domestic appliance of claim 3, wherein the resilient element is one of a helical or compression spring.
